(19) United States
(12) Patent Application Publication
(10) Pub. No.: US 2010/0266977 A1
(43) Pub. Date: Oct. 21, 2010

(54) ADJUSTABLE DENTAL WHIP ARM

(76) Inventors: Nilton Albano Junge, Santa Catarina (BR); Robert St. Louis, Charlotte, NC (US)

Correspondence Address: Beusse Wolter Sanks Mora & Maire, 390 N. ORANGE AVENUE, SUITE 2500, ORLANDO, FL, 32801, US

(21) Appl. No.: 12/727,495

(22) Filed: Mar. 19, 2010

Related U.S. Application Data
(63) Continuation-in-part of application No. 12/404,392, filed on Mar. 16, 2009.
(60) Provisional application No. 61/117,210, filed on Nov. 23, 2008.
(60) Provisional application No. 61/161,761, filed on Mar. 19, 2009.

(51) Int. Cl. A61C 19/00

(52) U.S. Cl. 433/78

(57) ABSTRACT

A dental whip arm assembly that includes a whip arm base with a whip arm pivot point, a whip arm insert with a locking pin, and a whip arm that is pivotally connected to the whip arm base and includes a slot that receives the whip arm insert in a plurality of insert positions. The whip arm rotates about the whip arm pivot point through a range of motion defined at one end by a fully retracted position, at the other end by a fully extended position, and at least one operating position between the fully retracted and the fully extended position. Further included is a locking mechanism connected to the whip arm base that engages the locking pin, thereby locking the whip arm in the operating position with respect to the whip arm base.

### RELATED APPLICATIONS

This application is a continuation-in-part of U.S. Ser. No. 12/404,392; filed Mar. 16, 2009, which claims priority to Provisional Application No. 61/117,210; filed Nov. 23, 2008. This application also claims priority to Provisional Patent Application No. 61/161,761 filed Mar. 19, 2009, the disclosures of which are incorporated herein in their entirety.

### FIELD OF THE INVENTION

The inventions of this application relate to dental delivery systems that house and deliver operating utilities to dental tools. More particularly the inventions relate to dental delivery systems employing an adjustable whip arm to secure the flexible utility conduit in an operating position.

### BACKGROUND

Dental procedures often require dental personnel to employ dental tools that require utility connections to a base unit, generally known as a dental delivery system base unit. The dental delivery system base is often the source for utilities required to operate the tools, such as, but not limited to rinsing water, compressed air, computer and video network cabling, and electricity etc. The utilities are usually delivered from the dental delivery system base unit to the dental tool via flexible conduits, such as plastic tubing, hoses, or cords etc. However, the distance between the dental delivery system base unit and the patient's mouth can require the flexible utility conduits to be several feet in length, and these lengths can interfere with dental procedures.

Several systems of managing these lengths of flexible utility conduits have been devised. These systems usually store the unused portion of the flexible utility conduits either suspended in an area by the dental delivery system base, or on a spring coiled spool, which takes up unused portions of spool as the unused length adjusts during a procedure. One particular system that has been devised is known in the art as the “whip arm.” A whip arm is a mechanism in which an arm, usually located on the patient side of a dental delivery system, is pivoted where it is connected to a base. A flexible utility conduit is run from the dental delivery system, away from the patient and through the whip arm, and then toward the patient, where it attaches to a dental tool and rests in a cradle, which is part of the dental delivery system base. The whip arm is usually lightly spring loaded to remain in its retracted position. When dental personnel pull on the dental tool, and associated flexible utility conduit, the force in the flexible utility conduit moves the whip from its retracted position, thus allowing the flexible utility conduit to travel with the dental tool, providing slack so the dental tool can be used. In such systems, constant tension remains on the flexible utility conduit, and dental tool, throughout the procedure.

### BRIEF DESCRIPTION OF THE DRAWINGS

The inventions are explained in the following description in view of the drawings that show:

FIG. 1 is a perspective view of a dental delivery system with multiple whip arms demonstrating three different locked positions of the present inventions.

FIG. 2 is a side view of a single whip arm assembly including a whip arm attached to a whip arm base.

FIG. 3 is a side view of the single whip arm assembly of FIG. 2 showing the whip arm in the operating position available for that whip arm assembly.

FIG. 4 is a side view of the whip arm assembly of FIG. 2, incorporating the adjustable locking mechanism of the present inventions.

FIG. 5 is a perspective view of a whip arm insert including a locking pin.

FIG. 6 is a perspective view of the whip arm and whip arm base of FIG. 4 showing a whip arm insert installed in the whip arm in a first position.

FIG. 8 is a perspective view of the whip arm and whip arm base of FIG. 4 showing a whip arm insert installed in the whip arm in a second position.

FIG. 8 is a perspective view of the whip arm and whip arm base of FIG. 4 showing a whip arm insert installed in the whip arm in a third position.

### DETAILED DESCRIPTION

The present inventors have realized the need for a dental whip arm mechanism that locks a dental whip arm into an operating position. Such a dental whip arm mechanism frees the dental tool from the constant forces applied to it by the dental whip arm via the utility conduit. A locking mechanism of this type is disclosed in concurrently filed application to U.S. application Ser. No. 12/404,392 which is incorporated herein it its entirety. Applicants have also recognized that a dental whip arm locking mechanism of this sort would further benefit if it were to be constructed to provide options as to where the dental whip arm is positioned when it is selectively locked into the operating position. This is of importance because different dental tools are often used in different orientations, and thus the position of the whip arm when in one operating position may be suitable for one tool but may not be suitable for another. Such an adjustable dental whip arm locking mechanism would provide greater flexibility to the operator, and thus improve the working conditions for the operator.

Accordingly, the inventors have designed an innovative dental whip arm having a selective locking mechanism that provides for multiple operating positions. One embodiment of the inventions is directed toward a dental whip arm assembly including a whip arm base with a whip arm pivot point, a whip arm insert with a locking pin, and a whip arm pivotally connected to the whip arm base with a slot that receives the whip arm insert in a plurality of insert positions. The whip arm rotates about the whip arm pivot point through a range of motion defined at one end by a fully retracted position, at the other end by a fully extended position, and at least one operating position between the fully retracted and the fully extended position. A locking mechanism connected to the whip arm base engages the locking pin, thereby locking the whip arm in the operating position with respect to the whip arm base.

Another embodiment is directed toward a dental delivery system including a dental delivery system housing, a dental utility flexible conduit, and an adjustable locking whip arm assembly. The adjustable locking whip arm assembly includes a whip arm base with a whip arm pivot, a whip arm insert with a locking pin, and a whip arm pivotally connected to the whip arm base with a slot that receives the whip arm insert in a plurality of insert positions. The whip arm rotates about the whip arm pivot through a range of motion defined at one end by a fully retracted position, at the other end by a fully extended position, and at least one operating position between the fully retracted and the fully extended position. A locking mechanism connected to the whip arm base engages the locking pin, thereby locking the whip arm in the operating position with respect to the whip arm base.

Yet another embodiment is directed toward a dental whip arm assembly for a dental delivery unit including a whip arm base, and a whip arm pivotally connected to the whip arm base. The whip arm pivots about a whip arm pivot point through a range of motion defined at one end by a fully retracted position, at the other end by a fully extended position, and at least one operating position between the fully retracted and the fully extended position. A locking pin is associated with the whip arm, the locking pin being adjustable in a plurality of positions on the whip arm, wherein adjustment of the locking pin effectuates a change in a location of the operating position.

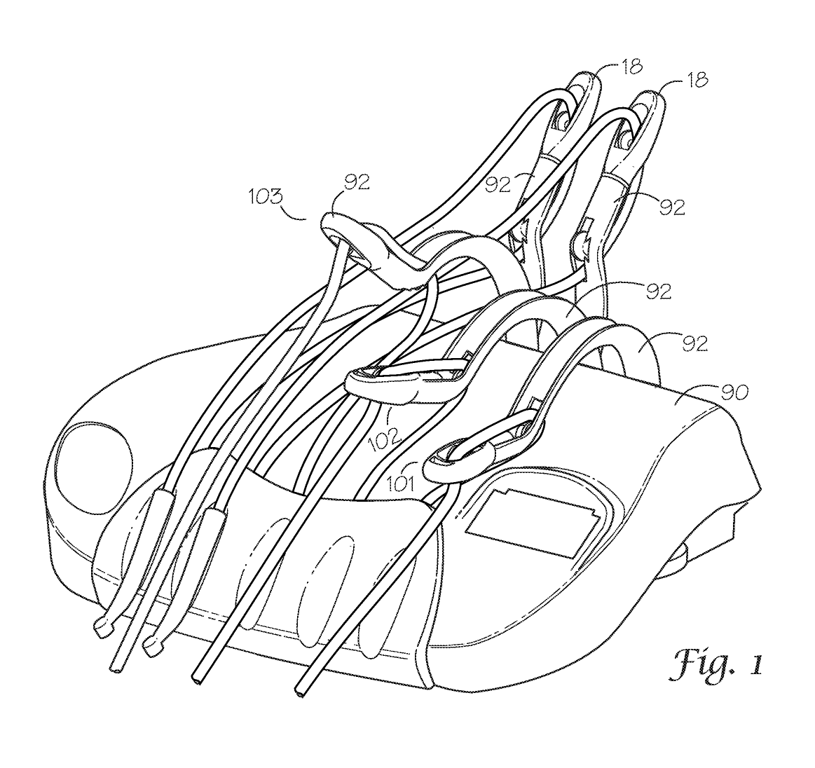

Turning to the drawings, FIG. 1 shows a dental delivery unit (90) with multiple whip arm assemblies (92) that incorporate the adjustable locking mechanism of the present inventions. The whip arm assemblies are depicted in operating positions (101), (102), and (103), and in a fully retracted position (18).

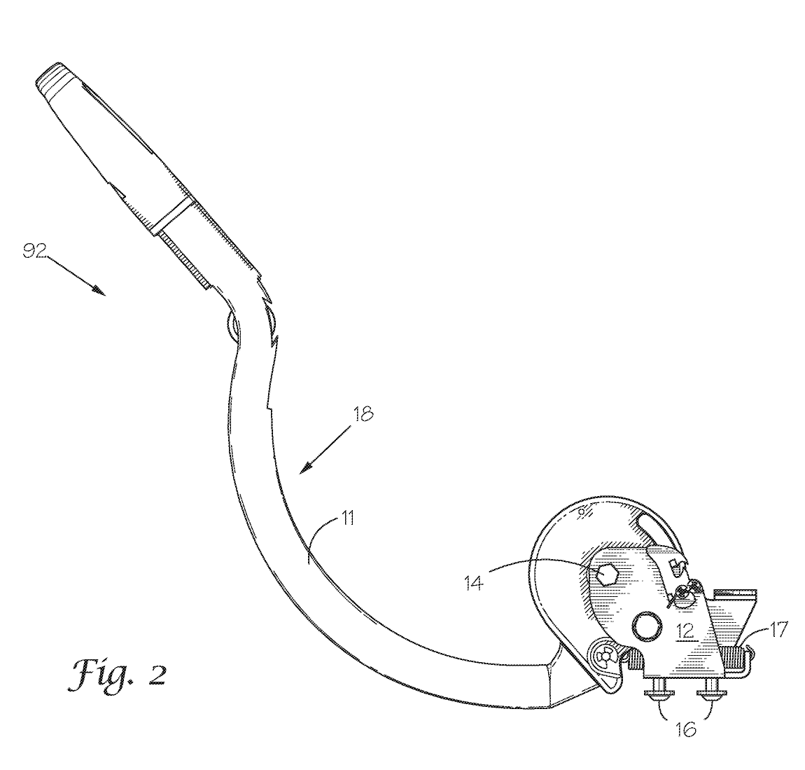

FIG. 2 is a side view of a locking whip arm assembly (92) without the adjustable locking mechanism of the present inventions, a whip arm (11), a whip arm base (12), and an axis (14) about which the whip arm (11) can rotate. A spring (17) holds the whip arm (11) in the retracted position (18) as shown. The whip arm base can be mounted to a dental delivery unit of FIG. 1 using mounting bolts (16) or any other suitable means.

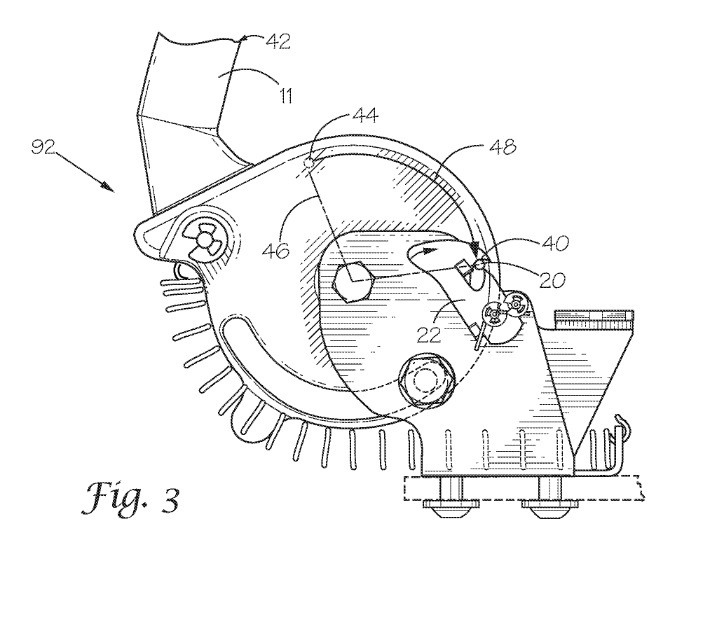

FIG. 3 is a close-up side view of the whip arm assembly (92) of FIG. 2, which shows a locking mechanism embodiment, but in this instance without adjustability, for purposes of demonstration the basic operation of such a locking whip arm assembly. FIG. 3 shows (a portion) of whip arm (11) once it has reached the operating position (42). Element (44) depicts the position of locking pin (20) when whip arm (11) is in the retracted position (18). Arrow (48) shows the circumferential path of travel that locking pin (20) takes as whip arm (11) extends from a retracted position (18) to the operating position (42). Upon sufficient extension of whip arm (11), latch plate (22) moves radially away from axis (14) to engage locking pin (20) in the locked position (40) of latch plate (22), thus locking the whip arm (11) in the operating position (42). Angle (46) shows a first amount of angular travel that locking pin (20) must cover in order for latch plate (22) to engage locking pin (20).

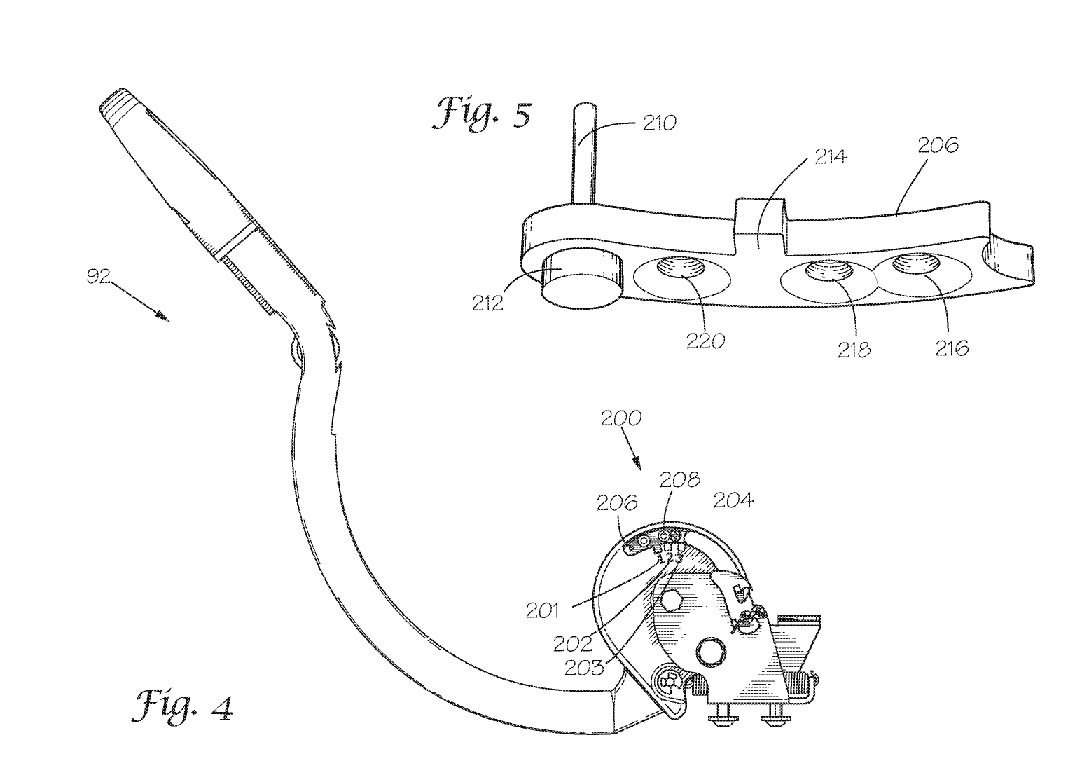

FIG. 4 is a side view of the whip arm assembly (92) of FIG. 2 incorporating an adjustable locking mechanism embodiment (200) of the present inventions. The adjustable locking mechanism (200) of the present inventions includes insert slot (204), insert (206), and fastener (208) that fastens insert (206) in place in insert slot (204).

FIG. 5 is a perspective view of insert (206) of the adjustable locking mechanism of the present inventions, showing locking pin (210), locking pin head (212), insert positioning projection (214), and position one fastener aperture (216), position two fastener aperture (218), and position three fastener aperture (220).

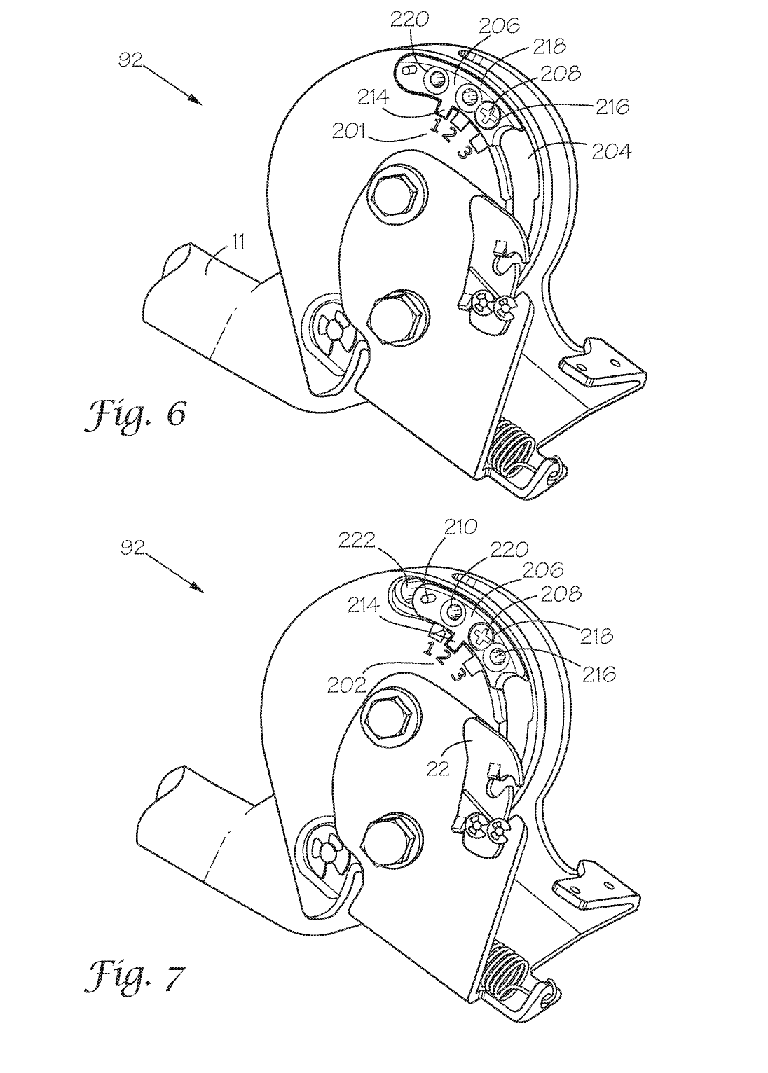

FIG. 6 is a perspective view of the whip arm assembly (92) of FIG. 4 in the fully retracted position (18). Insert (206) is positioned in insert slot (204), with insert positioning projection (214) located in recess (201), which corresponds to operating position (101). Fastener (208) fastens insert (206) to the whip arm (11) through fastener aperture (216) in insert (206). The whip arm (11) receives fastener (208) in a single location (not shown) and thus fastener (208) does not move its position with respect to the whip arm (11) regardless of where insert (11) is positioned in the insert slot (204). In an embodiment, the fastener is a screw, and whip arm (11) includes a female set of threads (not shown) in a single location. In order to reposition insert (206) to another position, fastener (208) is removed from the female threads in the whip arm (11), insert (206) is relocated in insert slot (204) such that insert positioning projection (214) is in another recess (201), (202), or (203), fastener (208) is installed through the fastener aperture (216), (218), or (220), and is threaded back into the female threads in the whip arm (11). Insert (206) includes multiple fastener apertures, one for each operating position, because fastener (208) remains in a single position with respect to the whip arm (11) when insert (208) is moved. Thus, there must be a fastener aperture for each operating position. The above-noted projection and recess arrangement could be reversed relative to the insert and the groove so that the projection is on the whip base and the recesses are in the insert.

FIG. 7 is a perspective view of the whip arm assembly (92) of FIG. 6, where insert (206) has been repositioned such that insert positioning projection (214) is located in recess (202). When positioning projection (214) is positioned in recess (202), the whip arm operating position will be operating position (102, see FIG. 1) when latch plate (22) catches locking pin (210). It can be seen that when insert (206) is moved in insert slot (204), locking pin (210) also moves relative to whip arm (11). Since latch plate (22) latches locking pin (210) into an operating position, a change in the location of locking pin (210) relative to whip arm (11) will result in a change in the operating position of the whip arm once latch plate (22) latches locking pin (210). Also visible in this embodiment is operating position (101) countersink (222), which receives locking pin head (212) when positioning projection (214) is in recess (201). Whip arm (11) has countersinks to receive locking pin head (212) whether positioning projection (214) is in recess (201), (202), or (203).

When insert (206) is positioned in insert slot (204) such that positioning projection (214) is in recess (201), as in FIG. 6, it can be seen that locking pin (210) is as far from latch plate (22) as insert slot (204) will permit. Consequently, whip arm (11) will have to rotate the most when insert (206) is in this position before latch plate (22) will engage locking pin (210). As a result, when in this configuration, operating position (101) results in whip arm (11) being furthest from the fully retracted position (18). When insert (206) is moved such that positioning projection (214) is in recess (202), as in FIG. 7, it can be seen that locking pin (210) has moved relatively closer to latch plate (22). Consequently, whip arm (11) will not need to rotate as far before latch plate (22) catches locking pin (210). As a result, when in this configuration, operating position (102) results in whip arm (11) being less extended than it is in operating position (101).

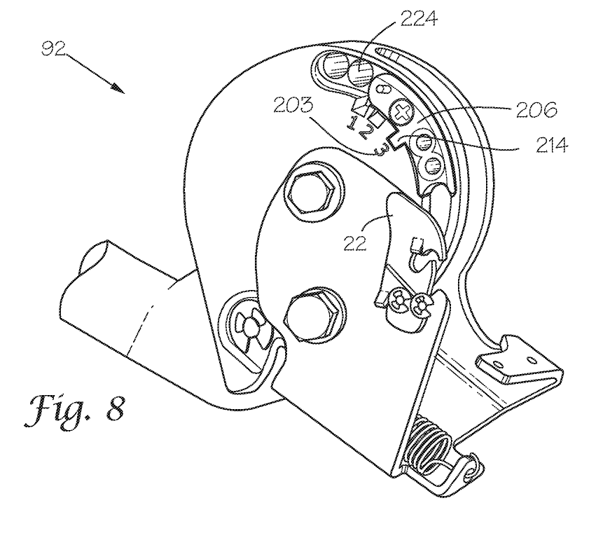

FIG. 8 shows insert (206) positioned such that positioning projection (214) is located in recess (203). It can be seen that insert (206) is as close to latch plate (22) as slot recess (204) will permit. Consequently, whip arm (11) will need to rotate only a little amount before latch plate (22) catches locking pin (210). As a result, when in this configuration, operating position (103) results in whip arm (11) being in a position that is closer to the fully retracted position (18) than when in operating position (102). Also visible is operating position 102 countersink (224) that receives locking pin head (212) when positioning projection (214) is in recess (202), as in FIG. 7.

In an alternative embodiment, the latch is carried on a latch insert movably mounted in a slot that is defined in the whip base. Similar to that described above for FIGS. 6-8, the latch insert can be adjusted so as to vary the positioning of the latch on the whip base, which in turn will vary the operating position of the whip arm. A projection and recess arrangement enables the position at which the lock members engage to be adjusted for adjusting the position of the whip arm relative to the whip base when the whip arm is in its operating position.

Thus, the Applicants has devised an innovative adjustable locking mechanism for a locking whip arm that permits the operator to position an insert in one of a plurality of positions, where each insert position corresponds to a different operating position of the whip arm. The simple, yet sturdy mechanism permits more accurate positioning of dental hand tools, increasing the efficiency and comfort of those using the dental hand tools.

While various embodiments of the present inventions have been shown and described herein, it will be obvious that such embodiments are provided by way of example only. Numerous variations, changes and substitutions may be made without departing from the inventions herein. Accordingly, it is intended that the inventions be limited only by the spirit and scope of the appended claims.

The invention claimed is:

1. A dental delivery unit for handling one or more dental whips, the dental delivery unit comprising:
a whip arm base adapted to be mounted to a dental delivery unit;
a whip arm connected to the whip arm base such that the whip arm retracts and extends relative to the whip base, and
a locking mechanism associated with the whip base and whip arm, wherein the locking mechanism releasably locks the whip arm in an operating position,
with the locking mechanism comprising a first lock member mounted on the whip arm and a second lock member mounted on the whip base engageable with the first lock member, with one of the lock members being movably mounted relative to the whip arm and the whip base for adjusting the relative position of the whip arm to the whip base when the lock members engage to hold the whip arm in its operating position.

2. The dental delivery unit of claim 1 wherein the first lock member is movably mounted relative to the whip arm and constitutes said one of the lock members.

3. The dental delivery unit of claim 2 wherein the first lock member comprises a lock pin carried on the whip arm.

4. The dental delivery unit of claim 3 wherein the lock pin is carried on an insert movably mounted within an elongate slot in the whip arm, with the insert being movable to different positions within the slot.

5. The dental delivery unit of claim 4 wherein the insert and slot present a projection and a plurality of recesses, with the projection being selectively positioned in any of the recesses for holding the insert in a desired position in the slot.

6. The dental delivery unit of claim 5 wherein the whip arm is mounted for pivotal movement about a generally horizontal axis through the whip base, with the insert and the slot being of generally arcuate shape about the axis.

7. The dental delivery unit of claim 1 wherein the second lock member is movably mounted relative to the whip base and constitutes said one of the lock members.

8. The dental delivery unit of claim 7 wherein the second lock member comprises a latch attached to the whip base and arranged to engage the first lock member when the whip arm moves to its operating position.

9. A dental whip arm assembly comprising:
a whip arm base comprising a whip arm pivot point;
a whip arm insert comprising a locking pin;
a whip arm pivotally connected to the whip arm base comprising a slot that receives the whip arm insert in a plurality of insert positions, wherein the whip arm rotates about the whip arm pivot point through a range of motion defined at one end by a fully retracted position, at the other end by a fully extended position, and at least one operating position between the fully retracted and the fully extended position; and
a locking mechanism connected to the whip arm base that engages the locking pin, thereby locking the whip arm in the operating position with respect to the whip arm base.

10. The dental whip arm assembly of claim 9, wherein the whip arm insert further comprises a positioning projection, and the whip arm further comprises a plurality of recesses that receive the positioning projection, wherein each recess corresponds to a different insert position.

11. The dental whip arm assembly of claim 9, further comprising a fastener that fastens the whip arm insert to the whip arm.

12. The dental whip arm assembly of claim 11, wherein the whip arm insert further comprises a plurality of fastener apertures through which the fastener passes, and wherein each fastener aperture corresponds to a different insert position.

13. The dental whip arm assembly of claim 11, wherein the whip arm receives the fastener at a single location, and wherein the fastener fastens the whip arm insert to the whip arm through the whip arm insert.

14. A dental delivery system comprising a dental delivery system housing, a dental utility flexible conduit, and an adjustable locking whip arm assembly, the adjustable locking whip arm assembly comprising:
a whip arm base comprising a whip arm pivot;
a whip arm insert comprising a locking pin;
a whip arm pivotally connected to the whip arm base comprising a slot that receives the whip arm insert in a plurality of insert positions, wherein the whip arm rotates about the whip arm pivot through a range of motion defined at one end by a fully retracted position, at the other end by a fully extended position, and at least one operating position between the fully retracted and the fully extended position; and
a locking mechanism connected to the whip arm base that engages the locking pin, thereby locking the whip arm in the operating position with respect to the whip arm base.

15. The dental delivery system of claim 14, wherein the whip arm insert further comprises a positioning projection, and the whip arm further comprises a plurality of recesses that receive the positioning projection, wherein each recess corresponds to a different insert position.

16. The dental delivery system of claim 14, further comprising a fastener that fastens the whip arm insert to the whip arm.

17. The dental delivery system of claim 16, wherein the fastener fastens to the whip arm at a single location, wherein the fastener fastens the whip arm insert to the whip arm through a fastener aperture in the whip arm insert, and wherein there is a fastener aperture to correspond to each different insert position.

18. A dental whip arm assembly for a dental delivery unit comprising:
a whip arm base;
a whip arm pivotally connected to the whip arm base wherein the whip arm pivots about a whip arm pivot point through a range of motion defined at one end by a fully retracted position, at the other end by a fully extended position, and at least one operating position between the fully retracted and the fully extended position;
a locking pin associated with the whip arm, the locking pin being adjustable in a plurality of positions on the whip arm,
wherein adjustment of the locking pin effectuates a change in a location of the operating position.

19. The dental whip arm assembly of claim 18, wherein the whip arm further comprises a slot that receives a whip arm insert in a plurality of insert positions, wherein each insert position changes the locking pin position, thereby changing the whip arm operating position.

20. The dental whip arm assembly of claim 19, wherein the whip arm insert further comprises a positioning projection, and the whip arm further comprises a plurality of recesses, each configured to receive the positioning projection, wherein each recess corresponds to a different insert position.

21. The dental whip arm assembly of claim 19, further comprising a fastener that fastens the whip arm insert to the whip arm.

22. The dental whip arm assembly of claim 21, wherein the whip arm insert further comprises a plurality of fastener apertures through which the fastener passes, to connect the whip arm insert to the whip arm, each fastener aperture corresponding to a different insert position.

23. A dental delivery system comprising a dental delivery system housing, dental utility flexible conduits, and the dental whip arm assembly of claim 18.
